(19) United States
(12) Patent Application Publication
(10) Pub. No.: US 2025/0361110 A1
(43) Pub. Date: Nov. 27, 2025

(54) IMAGE FORMING SYSTEM, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Joji SAITO, Kanagawa (JP); Haruhiko KOJIMA, Kanagawa (JP); Kosuke WAKASUGI, Kanagawa (JP); Hideo KIMURA, Kanagawa (JP); Ayumi IKEGAYA, Kanagawa (JP)

(73) Assignee: FUJIFILM Business Innovation Corp., Tokyo (JP)

(21) Appl. No.: 18/898,832

(22) Filed: Sep. 27, 2024

(30) Foreign Application Priority Data
May 24, 2024 (JP) 2024-085108

(51) Int. Cl. B65H 37/04; G03G 15/00

(52) U.S. Cl. CPC B65H 37/04; B65H 2301/51611; G03G 15/6544

(57) ABSTRACT

An image forming system includes one or plural processors. The one or plural processors are configured to cause binding processing of binding plural sheets of paper to create a paper bundle to be performed by selected one of the binding processing of staple processing using a staple and stapleless processing without using the staple, and perform, in a case where a predetermined event occurs in creating the paper bundle, first switching processing of switching the binding processing to the other binding processing.

### CROSS-REFERENCE TO RELATED APPLICATIONS

This application is based on and claims priority under 35 USC 119 from Japanese Patent Application No. 2024-085108 filed May 24, 2024.

### BACKGROUND

### (i) Technical Field

The present invention relates to an image forming system, a non-transitory computer readable medium storing program, and an image forming method.

### (ii) Related Art

There is a technique in which processing using a staple or processing without using the staple can be performed based on a selection of an operator in performing binding processing of binding a plurality of sheets of paper to form a paper bundle (refer to, for example, JP2015-040084A). In such a technique, in a case where an event, such as staple exhaustion or a failure, occurs in the middle of the binding processing using a selected binding processing method, the binding processing needs to be stopped until the event is resolved.

### SUMMARY

In a case where the event accompanied by the stop of the binding processing occurs in the middle of the binding processing using the selected binding processing method among the plurality of binding methods, there is a demand to continue the binding processing using another binding processing method.

Aspects of non-limiting embodiments of the present disclosure relate to an image forming system, a non-transitory computer readable medium storing program, and an image forming method that enable binding processing to be continued by another binding processing method even in a case where an event accompanied by stop of the binding processing occurs in a middle of the binding processing by a method of the binding processing selected from among a plurality of types of binding processing.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including one or a plurality of processors, in which the one or plurality of processors are configured to cause binding processing of binding a plurality of sheets of paper to create a paper bundle to be performed by selected one of the binding processing of staple processing using a staple and stapleless processing without using the staple, and perform, in a case where a predetermined event occurs in creating the paper bundle, first switching processing of switching the binding processing to the other binding processing.

### BRIEF DESCRIPTION OF THE DRAWINGS

Exemplary embodiment(s) of the present invention will be described in detail based on the following figures, wherein:

FIG. 1 is a diagram showing an example of an overall configuration of an image forming system to which the present exemplary embodiment is applied;

FIG. 2 is a diagram showing a configuration of a post-processing device configuring the image forming system of FIG. 1;

FIG. 3A is a diagram showing a movable range of a staple head in a case where staple processing is performed;

FIG. 3B is a diagram showing a specific example of a binding position of a paper bundle subjected to the staple processing;

FIG. 4A is a diagram showing a movable range of the staple head in a case where stapleless processing is performed;

FIG. 4B is a diagram showing a specific example of a binding position of a paper bundle subjected to the stapleless processing;

FIGS. 5A and 5B are diagrams showing specific examples in a case where a front and a back of the paper bundle are reversed by second switching processing;

FIG. 6 is a diagram showing a specific example in a case where first switching processing and the second switching processing are performed in the middle of binding processing and thus a discharge order of the paper bundle is opposite;

FIG. 7 is a diagram showing a specific example of a method of changing an order of a plurality of discharged paper bundles to combine the plurality of discharged paper bundles;

FIG. 8 is a diagram showing a specific example in a case where first interleaving paper and second interleaving paper are discharged;

FIG. 9 is a diagram showing an example of a hardware configuration of a control device configuring the post-processing device of FIG. 2; and

FIG. 10 is a diagram showing an example of a functional configuration of a control unit of the control device of FIG. 9.

### DETAILED DESCRIPTION

Hereinafter, exemplary embodiments of the present invention will be described in detail with reference to accompanying drawings.

### Configuration of Image Forming System 1

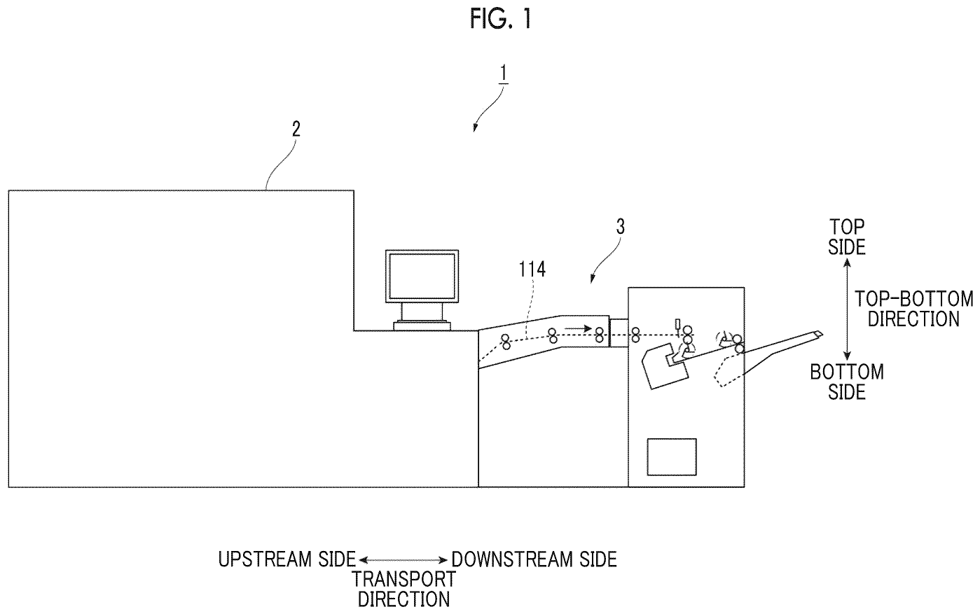

FIG. 1 is a diagram showing an example of an overall configuration of an image forming system 1 to which the present exemplary embodiment is applied.

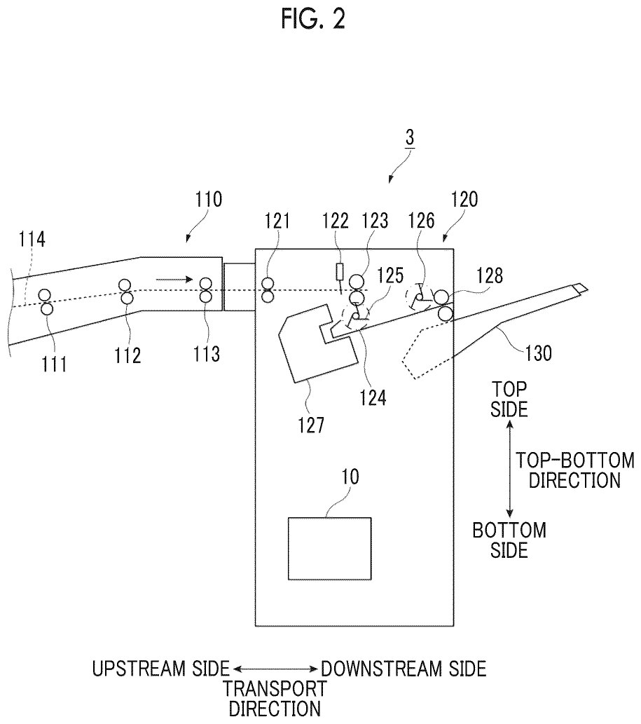

FIG. 2 is a diagram showing a configuration of a post-processing device 3 configuring the image forming system 1 of FIG. 1.

The image forming system 1 shown in FIG. 1 comprises an image forming apparatus 2 and the post-processing device 3 disposed on a downstream side of the image forming apparatus 2 in a transport direction.

### Image Forming Apparatus 2

The image forming apparatus 2 has a function of forming an image based on image data, a function of receiving an operation input or displaying various types of information, and the like. The image forming apparatus 2 is configured of, for example, a printer or a copier that forms an image on a recording material (for example, paper) by an electrophotographic method. The paper as the recording material on which the image forming apparatus 2 records the image is transported toward the post-processing device 3 along the transport path 114.

### Post-Processing Device 3

The post-processing device 3 performs post-processing on the paper on which the image forming apparatus 2 records (hereinafter referred to as “prints” in some cases) the image. The post-processing refers to processing such as various types of processes, bookbinding, packaging, and the like performed after the image is recorded on the paper. As shown in FIG. 2, the post-processing device 3 comprises a transport unit 110, a post-processing unit 120, and a stacker tray 130.

The transport unit 110 of the post-processing device 3 transports the paper, which is transported from the image forming apparatus 2 along the transport path 114, toward the post-processing device 3 by rolls 111 to 113 that transport the paper to a further downstream side.

The post-processing unit 120 of the post-processing device 3 performs processing of collecting and bundling a plurality of sheets of paper, processing of binding the plurality of bundled sheets of paper to create a paper bundle (hereinafter referred to as “binding processing”), or the like. The post-processing unit 120 can perform “staple processing” in which the binding processing is performed using a staple and “stapleless processing” in which the binding processing is performed without using the staple. The post-processing unit 120 has the staple used for the staple processing.

The post-processing unit 120 comprises a roll 121 that receives the paper transported by the transport unit 110, and an exit sensor 122 that detects the paper on a downstream side of the roll 121. Further, the post-processing unit 120 comprises a compile tray 124 that collects and loads the plurality of sheets of paper sequentially transported, and a roll 123 that discharges the paper toward the compile tray 124. Further, the post-processing unit 120 comprises a main paddle 125 and a sub paddle 126 that rotate to push the plurality of sheets of paper toward a stapler 127 that performs the binding processing. Further, the post-processing unit 120 comprises a roll 128 that transports the paper bundle loaded in the compile tray 124 toward the stacker tray 130 after the binding processing.

The stacker tray 130 of the post-processing device 3 stacks the transported paper bundle to be an aspect in which a user easily picks up the paper bundle. Further, the post-processing device 3 includes a control device 10 that controls the entire post-processing device 3. The control device 10 is provided in, for example, the post-processing unit 120. Details of a configuration of the control device 10 will be described below.

### Binding Processing

### Staple Processing

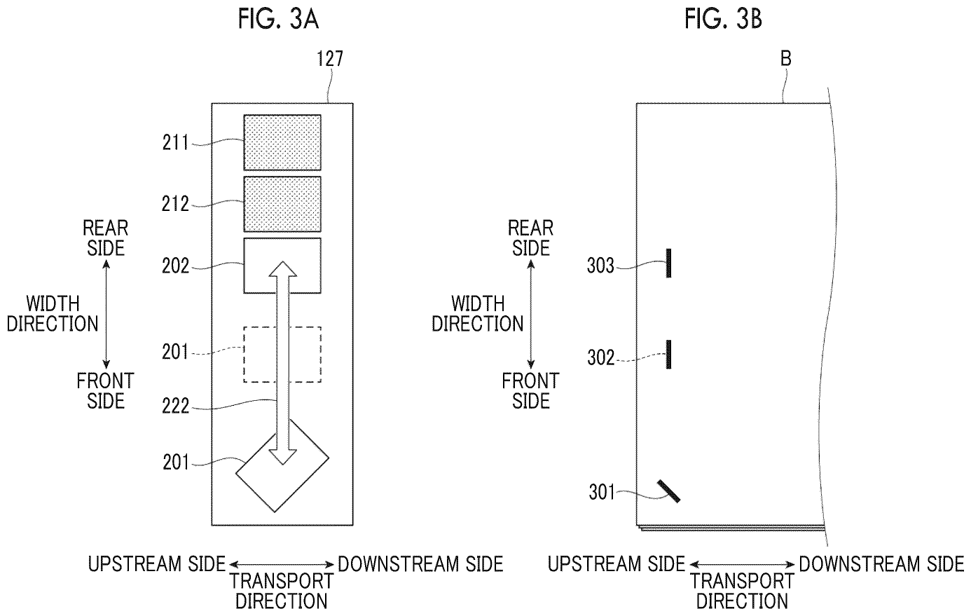

FIG. 3A is a diagram showing a movable range of a staple head in a case where the staple processing is performed. FIG. 3B is a diagram showing a specific example of a binding position of a paper bundle B subjected to the staple processing.

The stapler 127 of the post-processing unit 120 (refer to FIG. 2) of the post-processing device 3 comprises staple heads 201 and 202 as a staple processing mechanism that performs the staple processing. Further, the stapler 127 comprises staple heads 211 and 212 as a stapleless processing mechanism that performs the stapleless processing.

In a case where the staple processing is performed by the stapler 127, the staple heads 201 and 202 are moved in a width direction and insert the staple into a predetermined binding position of the paper bundle B to bind the paper bundle B. In this case, since the staple heads 211 and 212 that perform the stapleless processing are not used, the staple heads 211 and 212 are retracted to the vicinity of an end portion on a rear side in the width direction. For this reason, the movable range in which the staple heads 201 and 202 can be moved in the width direction to perform the staple processing is a limited range as indicated by an arrow 222.

The staple processing is selected from any one of “front staple processing” in which the staple is inserted into a binding position 301 of the paper bundle B to bind the paper bundle B, and “dual staple processing” in which the staple is inserted into each of binding positions 302 and 303 of the paper bundle B to bind the paper bundle B. In a case where the front staple processing is performed, the staple head 201 is moved to the vicinity of an end portion of the paper bundle B on a front side in the width direction, and the staple is inserted into the binding position 301 of the paper bundle B in a state of being rotated by about 45° to bind the paper bundle B.

In a case where the dual staple processing is performed, the staple heads 201 and 202 are respectively moved to the vicinity of a center portion of the paper bundle B in the width direction, and the staples are respectively inserted into the binding positions 302 and 303 of the paper bundle B to bind the paper bundle B. Although FIG. 3B exemplifies a state where the staple is inserted into all of the binding positions 301 to 303 of the paper bundle B, in reality, any one of the front staple processing or the dual staple processing is alternatively selected.

As described above, the staple processing is performed within the movable range of the staple heads 201 and 202 in the width direction, and the binding positions of the paper bundle B are limited to three positions (binding positions 301 to 303). For this reason, for example, there is a hardware limitation that the paper bundle B shown in FIG. 3B cannot be bound by inserting the staple into the vicinity of the end portion of the paper bundle B on the rear side in the width direction.

### Stapleless Processing

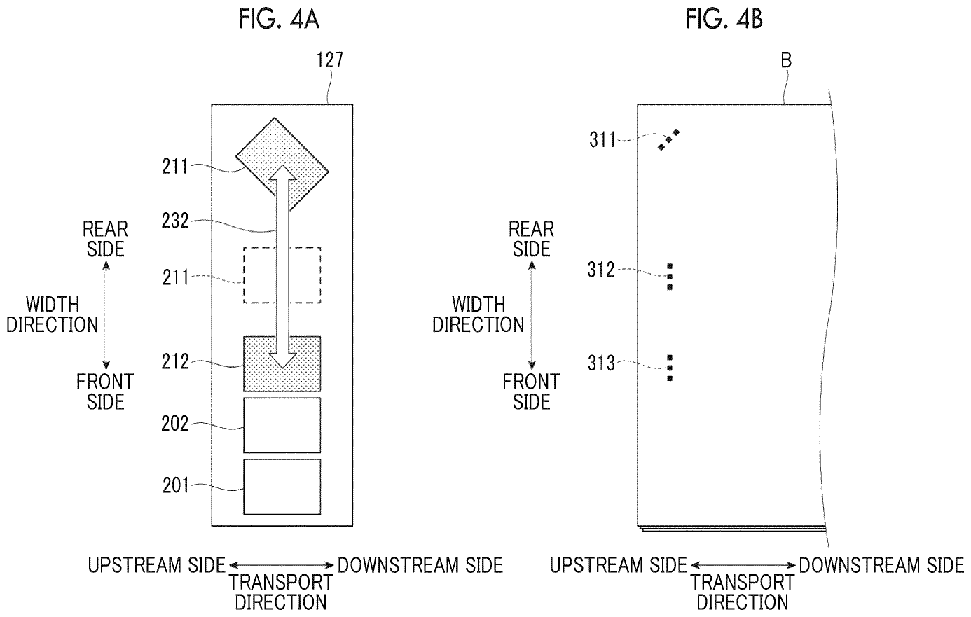

FIG. 4A is a diagram showing the movable range of the staple head in a case where the stapleless processing is performed. FIG. 4B is a diagram showing a specific example of the binding position of the paper bundle B subjected to the stapleless processing.

In a case where the stapleless processing is performed by the stapler 127, the staple heads 211 and 212 are moved in the width direction and insert the staple into the predetermined binding position of the paper bundle B to bind the paper bundle B. In this case, since the staple heads 201 and 202 that perform the staple processing are not used, the staple heads 201 and 202 are retracted to the vicinity of the end portion of the paper bundle B on the front side in the width direction. For this reason, the movable range in which the staple heads 211 and 212 can be moved in the width direction to perform the stapleless processing is a limited range as indicated by an arrow 232.

The stapleless processing is selected from any one of “rear stapleless processing” in which press binding or the like is performed at a binding position 311 of the paper bundle B to bind the paper bundle B, and “dual stapleless processing” in which the press binding or the like is performed at each of the binding positions 312 and 313 of the paper bundle B to bind the paper bundle B. In a case where the rear stapleless processing is performed, the staple head 211 is moved to the vicinity of the end portion of the paper bundle B on the rear side in the width direction, and the press binding or the like is performed at the binding position 311 of the paper bundle B in a state of being rotated by about 45° to bind the paper bundle B.

In a case where the dual stapleless processing is performed, the staple heads 211 and 212 are respectively moved to the vicinity of the center portion of the paper bundle B in the width direction, and the press binding or the like is performed at the binding positions 312 and 313 of the paper bundle B, respectively, to bind the paper bundle B. Although FIG. 4B exemplifies a state where the press binding or the like is performed at all of the binding positions 311 and 313 of the paper bundle B, in reality, any one of the rear stapleless processing or the dual stapleless processing is alternatively selected.

As described above, the stapleless processing is performed within the movable range of the staple heads 211 and 212 in the width direction, and the binding positions of the paper bundle B are limited to three positions (binding positions 311 to 313). For this reason, for example, there is a hardware limitation that the paper bundle B shown in FIG. 4B cannot be bound by performing the press binding or the like in the vicinity of the end portion of the paper bundle B on the front side in the width direction.

### First Switching Processing

In a case where “staple exhaustion”, which is an event that may hinder the continuation of the staple processing, occurs in the middle of the staple processing, the staple processing that requires the staple is automatically switched to the stapleless processing that does not require the staple. Hereinafter, such processing will be referred to as “first switching processing”. A configuration for realizing the first switching processing will be described below.

With the first switching processing, there is no need to replenish the staple in the middle of the binding processing. For example, in a case where the staple exhaustion occurs in the middle of the dual staple processing, the first switching processing is performed to automatically switch the processing to the dual stapleless processing. As shown in FIGS. 3B and 4B described above, even in a case where the dual staple processing is automatically switched to the dual stapleless processing, the binding position of the paper bundle B is not changed. That is, the binding positions 302 and 303 of the paper bundle B shown in FIG. 3B are the same or substantially the same as the binding positions 312 and 313 of the paper bundle B shown in FIG. 4B. Therefore, even in a case where the first switching processing is performed, the binding processing is continued without any problem.

### Second Switching Processing

On the contrary, the binding position 301 in a case where the front staple processing is performed is positioned near the end portion of the paper bundle B on an upstream side in the transport direction and the front side in the width direction, as shown in FIG. 3B. Further, the binding position 311 in a case where the rear stapleless processing is performed is positioned near the end portion of the paper bundle B on the upstream side in the transport direction and the rear side in the width direction, as shown in FIG. 4B. For this reason, in a case where the staple exhaustion occurs in the middle of the front staple processing and the processing is automatically switched to the rear stapleless processing by the first switching processing, a problem occurs in that the binding position of the paper bundle B is changed from the front side in the width direction to the rear side therein.

In the image forming system 1 according to the present exemplary embodiment, in a case where the staple exhaustion occurs in the middle of the front staple processing, each of a front and a back of the paper bundle B to be discharged and a discharge order of the paper bundle B is automatically switched. Hereinafter, such processing will be referred to as “second switching processing”. A configuration for realizing the second switching processing will be described below.

### Specific Examples of First Switching Processing and Second Switching Processing

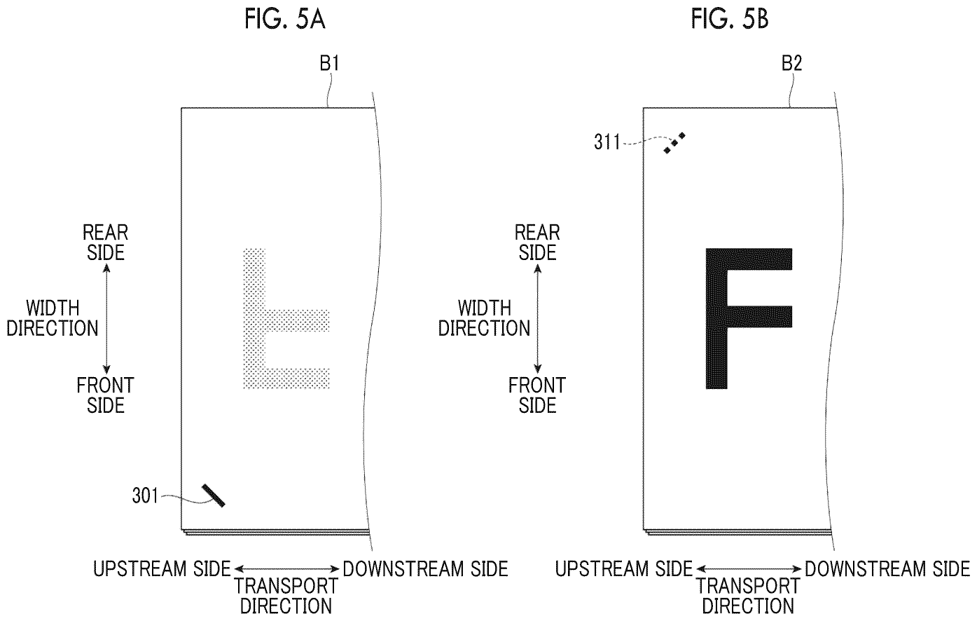

FIGS. 5A and 5B are diagrams showing a specific example in a case where the front and the back of the paper bundle are reversed by the second switching processing.

FIG. 5A shows a paper bundle B1 subjected to the front staple processing before the first switching processing and the second switching processing are performed. FIG. 5B shows a paper bundle B2 subjected to the rear stapleless processing after the first switching processing and the second switching processing are performed.

In a case where the front staple processing is performed, as shown in FIG. 5A, the paper bundle B1 is discharged such that a printing surface faces a bottom side in a top-bottom direction and an upper part of the printing surface is positioned on the front side in the width direction. In a case where the staple exhaustion occurs in the middle of the front staple processing, the first switching processing and the second switching processing are automatically performed to switch the processing to the rear stapleless processing. Further, as shown in FIG. 5B, the switching is performed such that the front and the back of the paper bundle B2 to be discharged are reversed in a direction (movement direction (width direction) of the staple head 201 or the like) orthogonal to a discharge direction (transport direction). That is, the paper bundle B2 is discharged such that the printing surface faces a top side in the top-bottom direction and the upper part of the printing surface is positioned on the rear side in the width direction. Accordingly, the binding position 301 at which the front staple processing is performed and the binding position 311 at which the rear stapleless processing is performed are at the same position or substantially the same position for the paper bundles B1 and B2. As a result, even in a case where the staple exhaustion occurs, the binding processing is continued without the replenishment of the staple.

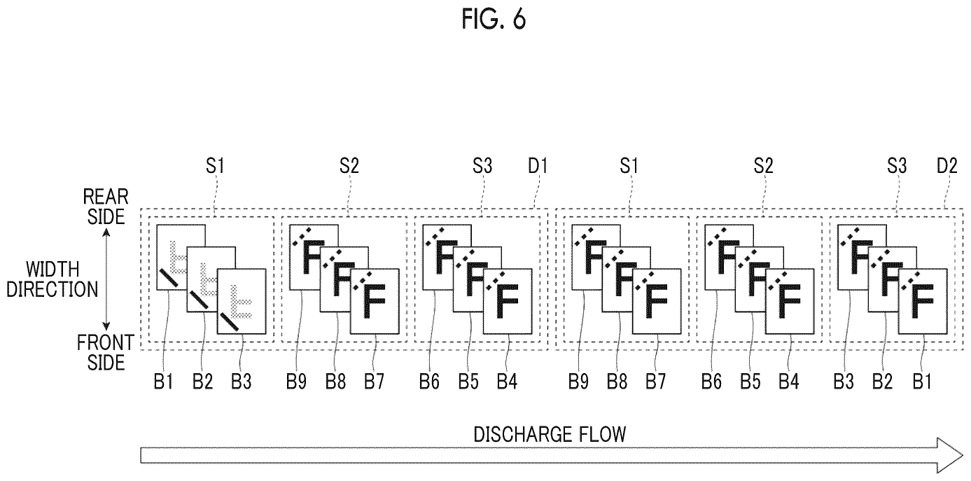

FIG. 6 is a diagram showing a specific example in a case where the first switching processing and the second switching processing are performed in the middle of the binding processing and thus the discharge order of the paper bundles is opposite.

The number of sheets of paper that can be bound by single binding processing of the stapler 127 (refer to FIG. 2) is limited. For this reason, in a case where a total number of pages of manuscript data to be printed exceeds the number of sheets of paper that can be bound by single binding processing, the sheets of paper are divided into a plurality of paper bundles and discharged. For example, in a case where the total number of pages of the manuscript data to be printed on one side is 90 pages and the number of sheets of paper that can be bound by single binding processing is 10 sheets, nine paper bundles (10 sheets×9=90 sheets) are discharged in accordance with an order of pages of the manuscript data. The user combines the discharged nine paper bundles using a method such as bookbinding to create one printed matter.

The discharge order of the nine divided paper bundles is considered such that the post-discharge combining is facilitated, and is different between a case where the binding processing is the front staple processing and a case where the binding processing is the rear stapleless processing. That is, in a case where the binding processing is the front staple processing, the paper bundle is discharged such that the printing surface faces the bottom side in the top-bottom direction and the upper part of the printing surface is positioned on the front side in the width direction. Thus, the paper bundles are sequentially discharged such that page numbers of the manuscript data are in ascending order. On the contrary, in a case where the binding processing is the rear stapleless processing, the paper bundle is discharged such that the printing surface faces the top side in the top-bottom direction and the upper part of the printing surface is positioned on the rear side in the width direction. Thus, the paper bundles are sequentially discharged such that the page numbers of the manuscript data are in descending order.

However, in a case where the staple exhaustion occurs in the middle of the front staple processing and the first switching processing and the second switching processing are performed, the front and the back of the paper bundle are reversed as described above, and the discharge order of the paper bundle is opposite. For this reason, in a case where the plurality of discharged paper bundles are combined as the plurality of discharged paper bundles are, the front and the back of the printing surface are not uniform in one printed matter and the order of pages is mixed. Thus, in a case where the staple exhaustion occurs in the middle of the front staple processing and the first switching processing and the second switching processing are performed, the user needs to combine the paper bundles while the order of the paper bundle is changed as appropriate in consideration of the discharge order of the paper bundle.

FIG. 6 shows an example in a case where the first switching processing and the second switching processing are performed since the staple exhaustion occurs in the middle of the creation of the printed matter, which is obtained by combining the paper bundles B1 to B9 in that order. In the example of FIG. 6, the front staple processing is continuously performed three times, and the staple exhaustion occurs at a timing at which the paper bundles B1 to B3 (first set S1) are created. Thus, the front staple processing is switched to the rear stapleless processing as the first switching processing, and the front and the back of the paper bundle are reversed and the discharge order of the paper bundle is opposite as the second switching processing.

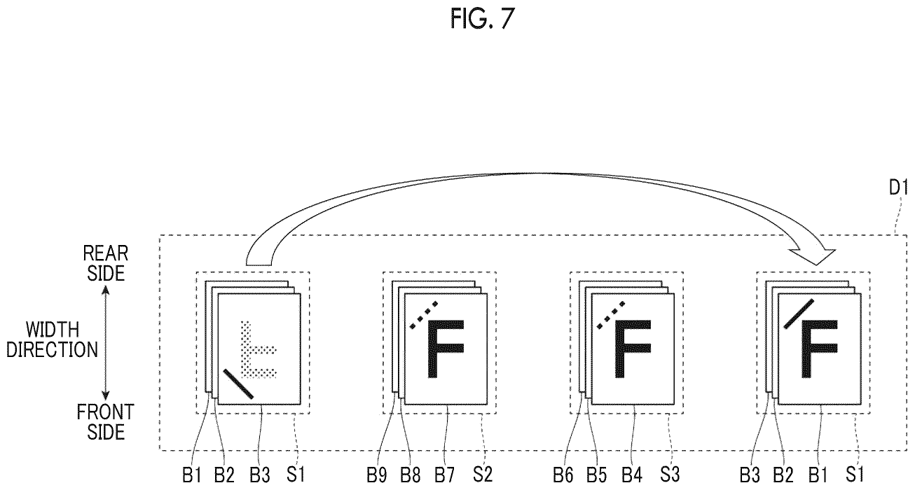

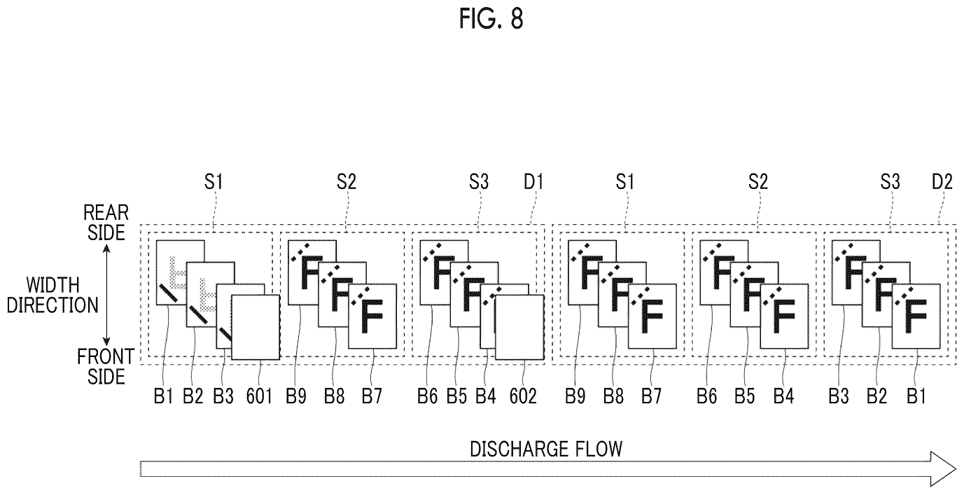

Specifically, after the paper bundle B3 is discharged, the paper bundle B9 in which the front and the back are reversed with respect to the paper bundle B3 is discharged, and the paper bundles B8 and B7 (second set S2 including the paper bundle B9) and the paper bundles B6 to B4 (third set S3) are further discharged in that order. Accordingly, since all the paper bundles B1 to B9 are discharged, a first part D1 of the printed matter can be created by combining the paper bundles B1 to B9. However, since the first switching processing and the second switching processing are performed in the middle of the continuous performing of the front staple processing, the user needs to combine the paper bundles B1 to B9 while the order of the paper bundle is changed as appropriate in consideration of the discharge order of the paper bundle. Specific methods in a case where the paper bundles B1 to B9 are combined while the order of the paper bundles is changed will be described below with reference to FIGS. 7 and 8.

Further, in the example of FIG. 6, after the discharge of the paper bundle B4 of the first part D1, the paper bundles B1 to B9 of a second part D2 are discharged in descending order. Accordingly, the second part D2 of the printed matter can be created by combining the paper bundles B1 to B9. In the second part D2, since the paper bundles B1 to B9 are discharged in descending order, the paper bundles can be combined without changing the order of the paper bundles.

FIG. 7 is a diagram showing a specific example of a method of combining the plurality of discharged paper bundles by changing the order of the plurality of discharged paper bundles.

In the example of FIG. 6 described above, the first switching processing and the second switching processing are performed in the middle of the continuous performing of the front staple processing. Thus, the user needs to combine the paper bundles B1 to B9 of the first part D1 while the order of the paper bundles B1 to B9 is changed as appropriate in consideration of the discharge order of the paper bundles.

Specifically, as shown in FIG. 7, regarding the discharge order of the paper bundles B1 to B9 of the first part D1, the paper bundles B1 to B3 (first set S1) are discharged in ascending order, the paper bundles B7 to B9 (second set S2) are discharged in descending order, and the paper bundles B4 to B6 (third set S3) are discharged in descending order. Among the paper bundles B1 to B9, the paper bundles B1 to B3 (first set S1) are bound by the front staple processing, and thus are discharged such that the printing surface faces the bottom side in the top-bottom direction and the upper part of the printing surface is positioned on the front side in the width direction. On the contrary, the paper bundles B7 to B9 (second set S2) and the paper bundles B4 to B6 (third set S3) are bound by the rear stapleless processing, and thus are discharged such that the printing surfaces face the top side in the top-bottom direction and the upper parts of the printing surfaces are positioned on the rear side in the width direction.

Thus, as indicated by an arrow in FIG. 7, the user reverses the front and the back of the paper bundles B1 to B3 (first set S1) in the width direction and changes the order of the paper bundles such that the order of the paper bundles B1 to B3 is earlier than the order of the paper bundles B4 to B6 (third set S3). Accordingly, the user can combine the paper bundles B1 to B9 of the first part D1 in that order.

### Discharge of First Interleaving Paper and Second Interleaving Paper

FIG. 8 is a diagram showing a specific example in a case where first interleaving paper 601 and second interleaving paper 602 are discharged.

In a case where the first switching processing and the second switching processing are performed in the middle of the continuous performing of the front staple processing, the image forming system 1 (refer to FIG. 1) discharges each of the first interleaving paper 601 and the second interleaving paper 602 at a predetermined timing. The configuration of discharging the first interleaving paper 601 and the second interleaving paper 602 is to improve the convenience of the user and is not indispensable.

The first interleaving paper 601 serves as a mark indicating that the second switching processing is performed. The first interleaving paper 601 is discharged after the second switching processing is performed and before a next paper bundle is discharged. Specifically, for example, in a case where the examples shown in FIGS. 6 and 7 described above are used as a base, the first interleaving paper 601 is discharged at a timing shown in FIG. 8. That is, the first interleaving paper 601 is discharged after the paper bundle B3 of the first set S1 is created and the first switching processing and the second switching processing are performed due to the staple exhaustion, and before the paper bundle B9 is discharged.

The second interleaving paper 602 serves as a mark indicating that the number of created paper bundles has reached a predetermined number. The second interleaving paper 602 is discharged after the number of created paper bundles has reached the predetermined number and before a next paper bundle is discharged. Specifically, for example, in a case where the examples shown in FIGS. 6 and 7 described above are used as a base, the second interleaving paper 602 is discharged at a timing shown in FIG. 8. That is, the second interleaving paper 602 is discharged after the number of created paper bundles has reached nine, which is the total number of paper bundles of the first part D1, with the creation of the paper bundle B4 of the third set S3, and before the paper bundle B9 of the first set S1 of the second part D2 is discharged.

The first interleaving paper 601 and the second interleaving paper 602 may be subjected to, for example, printing with a message indicating that the first switching processing or the second switching processing is performed, color coding, or the like such that the user can find the interleaving paper at a glance.

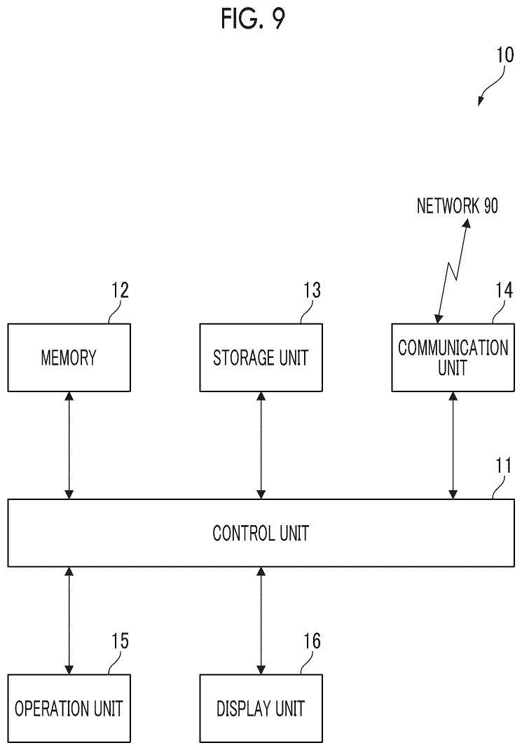

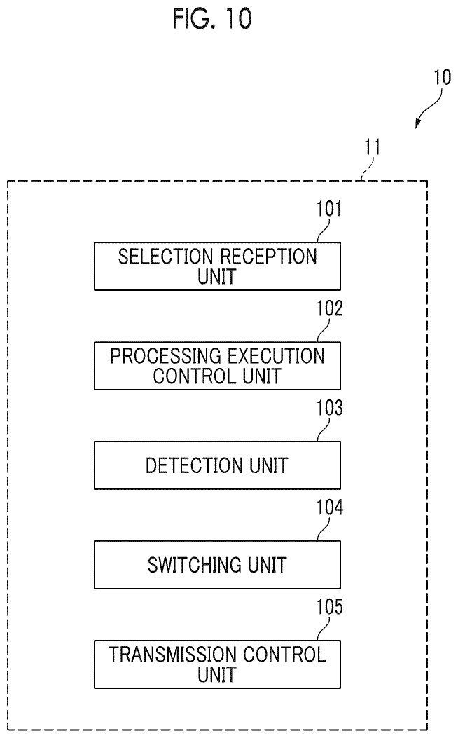

The above binding processing described with reference to FIGS. 3A to 8 is realized by the control of the processing of the post-processing device 3 by the control device 10 shown in FIG. 2. Hereinafter, the details of the configuration of the control device 10 that realizes the above binding processing will be described with reference to FIGS. 9 and 10.

### Hardware Configuration of Control Device 10

FIG. 9 is a diagram showing an example of a hardware configuration of the control device 10 configuring the post-processing device 3 in FIG. 2.

The control device 10 includes a control unit 11, a memory 12, a storage unit 13, a communication unit 14, an operation unit 15, and a display unit 16. The above units are connected to each other via a data bus, an address bus, a peripheral component interconnect (PCI) bus, or the like.

The control unit 11 is a processor that controls functions of the control device 10 based on execution of various types of software such as an OS (basic software) and application software. The control unit 11 is configured of, for example, a central processing unit (CPU). The memory 12 is a storage region in which various types of software, pieces of data used for executing the software, or the like are stored, and is used as a work area in calculations. The memory 12 is configured of, for example, a random access memory (RAM).

The storage unit 13 is a storage region in which input data for various types of software, output data from various types of software, or the like are stored. The storage unit 13 is configured of, for example, a hard disk drive (HDD), a solid state drive (SSD), or a semiconductor memory, which is used for storing programs, various types of setting data, or the like. The storage unit 13 is provided with a database that stores various types of information.

The communication unit 14 transmits and receives data to and from the outside via a network 90 such as the Internet or a local area network (LAN). The operation unit 15 is configured of, for example, a keyboard, a mouse, a mechanical button, or a switch, and receives an input operation. The operation unit 15 also includes a touch sensor integrally configuring a touch panel with the display unit 16. The display unit 16 is configured of, for example, a liquid crystal display or an organic electro luminescence (=EL) display to be used for information display, and displays data of an image or a text and the like. The display unit 16 displays a user interface or the like.

### Functional Configuration of Control Device 10

FIG. 10 is a diagram showing an example of a functional configuration of the control unit 11 of the control device 10 in FIG. 9.

A selection reception unit 101, a processing execution control unit 102, a detection unit 103, a switching unit 104, and a transmission control unit 105 function in the control unit 11 of the control device 10.

The selection reception unit 101 receives various pieces of selection by the input operation. For example, the selection reception unit 101 receives the selection of the binding processing by the input operation. Specifically, for example, the selection reception unit 101 receives the selection of the staple processing or the stapleless processing, as the selection of the binding processing. Further, for example, the selection reception unit 101 receives selection of the front staple processing or the dual staple processing in a case where the staple processing is selected, as the selection of the binding processing. Further, for example, the selection reception unit 101 receives the selection of the rear stapleless processing or the dual stapleless processing in a case where the stapleless processing is selected, as the selection of the binding processing.

The processing execution control unit 102 performs control of executing the binding processing by the stapler 127 (refer to FIG. 2). For example, in a case where the selection reception unit 101 receives the selection of the staple processing, the processing execution control unit 102 causes the stapler 127 to execute the staple processing. Further, in a case where the selection reception unit 101 receives the selection of the front staple processing, the processing execution control unit 102 causes the stapler 127 to execute the front staple processing. Further, in a case where the selection reception unit 101 receives the selection of the dual staple processing, the processing execution control unit 102 causes the stapler 127 to execute the dual staple processing.

Further, for example, in a case where the selection reception unit 101 receives the selection of the stapleless processing, the processing execution control unit 102 causes the stapler 127 to execute the stapleless processing. Further, in a case where the selection reception unit 101 receives the selection of the rear stapleless processing, the processing execution control unit 102 causes the stapler 127 to execute the rear stapleless processing. Further, in a case where the selection reception unit 101 receives the selection of the dual stapleless processing, the processing execution control unit 102 causes the stapler 127 to execute the dual stapleless processing.

The detection unit 103 detects the staple exhaustion occurred in the stapler 127. Specifically, in a case where the staple exhaustion occurs in the middle of the staple processing (front staple processing or dual staple processing), the detection unit 103 detects the staple exhaustion.

The switching unit 104 performs the first switching processing and the second switching processing. Specifically, in a case where the staple exhaustion is detected in the middle of the staple processing, the switching unit 104 switches the staple processing to the rear stapleless processing, as the first switching processing. Further, the switching unit 104 performs the second switching processing in accordance with contents of the first switching processing. For example, in a case where the front staple processing is switched to the rear stapleless processing, the switching unit 104 switches each of the front and the back of the paper bundle to be discharged and the discharge order of the paper bundle, as the second switching processing. Similarly, even in a case where the rear stapleless processing is switched to the front staple processing, the switching unit 104 switches each of the front and the back of the paper bundle to be discharged and the discharge order of the paper bundle, as the second switching processing.

The transmission control unit 105 performs control of transmitting various types of information toward the outside of the image forming system 1 via the communication unit 14 (refer to FIG. 9). For example, the transmission control unit 105 may perform control of performing transmission to an outside information processing apparatus (for example, a user terminal used by the user) via the communication unit 14 to notify the user that the first switching processing or the second switching processing is performed. In this case, a configuration may be employed in which the first switching processing or the second switching processing requires prior approval of the user. The configuration in which the user is notified that the first switching processing or the second switching processing is performed is to improve the convenience of the user and is not indispensable.

### Other Exemplary Embodiments

Although the present exemplary embodiment has been described above, the present invention is not limited to the present exemplary embodiment. Further, effects of the present invention are not limited to the effects disclosed in the present exemplary embodiment. For example, the configurations of the image forming system 1 shown in FIGS. 1 and 2, the configurations of the binding processing shown in FIGS. 3A to 4B, and the configurations of the first switching processing and the second switching processing shown in FIGS. 5A to 7 are merely examples for achieving the object of the present invention, and are not particularly limited. Further, the configuration in which the first interleaving paper 601 and the second interleaving paper 602 are discharged, shown in FIG. 8, is merely an example for achieving the object of the present invention, and is not particularly limited.

Further, the hardware configuration shown in FIG. 9 and the functional configuration shown in FIG. 10 are merely examples for achieving the object of the present invention, and are not particularly limited. That is, as long as the image forming system 1 of FIG. 1 has the function of executing the above pieces of processing as a whole, what kind of hardware configuration and functional configuration are used to realize the function is not limited to the above examples. For example, as described above, an information processing apparatus such as a user terminal used by one or each of a plurality of users may be connected to the image forming system 1 in FIG. 1. Accordingly, for example, in order to improve the convenience of the user, the user may be notified that the first switching processing or the second switching processing is performed.

Further, in the exemplary embodiment described above, in a case where the so-called staple exhaustion occurs as an event that may hinder the continuation of the binding processing, the first switching processing is automatically performed. However, the event that may hinder the continuation of the binding processing is not limited to the staple exhaustion. For example, a case where the staple head 201 (refer to FIG. 3A) performing the staple processing fails may be also the event that may hinder the continuation of the binding processing.

Further, in the exemplary embodiment described above, the description has been made in which the first switching processing is performed to switch the binding processing from the staple processing to the stapleless processing, but the present disclosure is not limited thereto. For example, in a case where the staple head 211 (refer to FIG. 4A) performing the stapleless processing fails, the first switching processing is performed to switch the processing from the stapleless processing to the staple processing.

### Supplementary Note

(((1)))

An image forming system comprising:
one or a plurality of processors configured to:
   cause binding processing of binding a plurality of sheets of paper to create a paper bundle to be performed by selected one of the binding processing of staple processing using a staple and stapleless processing without using the staple; and
   perform, in a case where a predetermined event occurs in creating the paper bundle, first switching processing of switching the binding processing to the other binding processing.

(((2)))

The image forming system according to (((1))), wherein the one or plurality of processors are configured to:
perform the first switching processing in a case where an event that hinders a continuation of the selected one of the binding processing occurs as the predetermined event.

(((3)))

The image forming system according to (((2))), wherein the one or plurality of processors are configured to:
in a case where staple exhaustion occurs in a staple processing mechanism that performs the staple processing, as the event that hinders the continuation, switch the binding processing from the staple processing to the stapleless processing as the first switching processing.

(((4)))

The image forming system according to any one of (((1))) to (((3))), wherein the one or plurality of processors are configured to:
perform, in a case where the predetermined event occurs, second switching processing of switching each of a front and a back of the paper bundle to be discharged and a discharge order of the paper bundle in accordance with a binding position of the paper bundle to be subjected to the binding processing started after the first switching processing.

(((5)))

The image forming system according to (((4))),
wherein each of a staple processing mechanism that performs the staple processing and a stapleless processing mechanism that performs the stapleless processing is movable in a movement direction orthogonal to a discharge direction in which the paper bundle is discharged, and
a first binding position of the paper bundle to be subjected to the staple processing and a second binding position of the paper bundle to be subjected to the stapleless processing, as binding positions, are different from each other in a movement direction.

(((6)))

The image forming system according to (((5))),
wherein the first binding position is on one end side of the paper bundle in the movement direction, and the second binding position is on the other end side of the paper bundle in the movement direction.

(((7)))

The image forming system according to any one of (((4))) to (((6))), wherein the one or plurality of processors are configured to:
switch the binding processing from the staple processing to the stapleless processing, as the first switching processing, and perform switching such that a front and a back of the paper bundle to be discharged are reversed in the movement direction and perform switching such that a discharge order of the paper bundle is opposite, as the second switching processing.

(((8)))

The image forming system according to any one of (((4))) to (((7))), wherein the one or plurality of processors are configured to:
discharge first interleaving paper as a mark indicating that the second switching processing is performed, after the second switching processing is performed and before a next paper bundle is discharged.

(((9)))

The image forming system according to (((8))), wherein the one or plurality of processors are configured to:
discharge second interleaving paper as a mark indicating that the number of created paper bundles reaches a predetermined number, after the number of created paper bundles reaches the predetermined number and before a next paper bundle is discharged.

(((10)))

A program that causes a computer to realize a function, the function comprising:
causing binding processing of binding a plurality of sheets of paper to create a paper bundle to be performed by selected one of the binding processing of staple processing using a staple and stapleless processing without using the staple; and
performing, in a case where a predetermined event occurs in creating the paper bundle, first switching processing of switching the binding processing to the other binding processing.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
one or a plurality of processors configured to:
cause binding processing of binding a plurality of sheets of paper to create a paper bundle to be performed by selected one of the binding processing of staple processing using a staple and stapleless processing without using the staple; and
perform, in a case where a predetermined event occurs in creating the paper bundle, first switching processing of switching the binding processing to the other binding processing.

2. The image forming system according to claim 1, wherein the one or plurality of processors are configured to:
perform the first switching processing in a case where an event that hinders a continuation of the selected one of the binding processing occurs as the predetermined event.

3. The image forming system according to claim 2, wherein the one or plurality of processors are configured to:
in a case where staple exhaustion occurs in a staple processing mechanism that performs the staple processing, as the event that hinders the continuation, switch the binding processing from the staple processing to the stapleless processing as the first switching processing.

4. The image forming system according to claim 1, wherein the one or plurality of processors are configured to:
perform, in a case where the predetermined event occurs, second switching processing of switching each of a front and a back of the paper bundle to be discharged and a discharge order of the paper bundle in accordance with a binding position of the paper bundle to be subjected to the binding processing started after the first switching processing.

5. The image forming system according to claim 4,
wherein each of a staple processing mechanism that performs the staple processing and a stapleless processing mechanism that performs the stapleless processing is movable in a movement direction orthogonal to a discharge direction in which the paper bundle is discharged, and
a first binding position of the paper bundle to be subjected to the staple processing and a second binding position of the paper bundle to be subjected to the stapleless processing, as binding positions, are different from each other in a movement direction.

6. The image forming system according to claim 5,
wherein the first binding position is on one end side of the paper bundle in the movement direction, and the second binding position is on the other end side of the paper bundle in the movement direction.

7. The image forming system according to claim 6, wherein the one or plurality of processors are configured to:
switch the binding processing from the staple processing to the stapleless processing, as the first switching processing, and perform switching such that a front and a back of the paper bundle to be discharged are reversed in the movement direction and perform switching such that a discharge order of the paper bundle is opposite, as the second switching processing.

8. The image forming system according to claim 4, wherein the one or plurality of processors are configured to:
discharge first interleaving paper as a mark indicating that the second switching processing is performed, after the second switching processing is performed and before a next paper bundle is discharged.

9. The image forming system according to claim 8, wherein the one or plurality of processors are configured to:
discharge second interleaving paper as a mark indicating that the number of created paper bundles reaches a predetermined number, after the number of created paper bundles reaches the predetermined number and before a next paper bundle is discharged.

10. A non-transitory computer readable medium storing program that causes a computer to realize a function, the function comprising:
causing binding processing of binding a plurality of sheets of paper to create a paper bundle to be performed by selected one of the binding processing of staple processing using a staple and stapleless processing without using the staple; and
performing, in a case where a predetermined event occurs in creating the paper bundle, first switching processing of switching the binding processing to the other binding processing.

11. An image processing method comprising:
causing binding processing of binding a plurality of sheets of paper to create a paper bundle to be performed by selected one of the binding processing of staple processing using a staple and stapleless processing without using the staple; and
performing, in a case where a predetermined event occurs in creating the paper bundle, first switching processing of switching the binding processing to the other binding processing.
